(19) United States
(12) Patent Application Publication
(10) Pub. No.: US 2006/0229063 A1
(43) Pub. Date: Oct. 12, 2006

(54) Systems and methods automatically updating contact information

(75) Inventor: Zeke Koch, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/104,025

(22) Filed: Apr. 12, 2005

(51) Int. Cl. H04Q 7/38

(52) U.S. Cl. 455/414.1; 455/418

(57) ABSTRACT

The subject invention provides a system and/or a method that facilitates automatically updating contact information. An interface can receive identification data related to a first mobile communication device, wherein a contact update component can provide contact information to a second mobile communication device and automatically update such contact information. The update can be before, during, and/or after a communication session between the first mobile communication device and the second mobile communication device. Moreover, the update can be applied to an address book and/or a memory storage associated with the second mobile communication device.

### TECHNICAL FIELD

The present invention generally relates to wireless communications, and more particularly to systems and/or methods that facilitate automatically updating and/or storing contact information associated with such wireless communications.

### BACKGROUND OF THE INVENTION

In the not too distant past, mobile communication devices in general, and mobile telephones in particular, were luxury items only affordable to those with substantial income. Furthermore, these mobile telephones were significant in size, rendering them inconvenient for extended portability based at least in part upon size (e.g., battery, housing, circuitry, etc.). For example, in contrast to today's mobile telephones (and other mobile communication devices), mobile telephones of the recent past could not be placed into a user's pocket and/or handbag without causing extreme discomfort. In other words, the benefit of mobile communications was diminished due to the inconvenient characteristics associated with such former mobile communication devices.

The development, refinement, and advancements in mobile communications have rapidly increased to allow convenient and efficient mobile communications and/or mobile communication devices, wherein such above-described deficiencies have been overcome. Mobile communication devices have added functionality (e.g., game applications, web access, storage capacity, address books, display size, ergonomics, battery life, capture/display images, capture/display video, text message, etc.), while also decreased in size (e.g., housing, circuitry, battery, etc.). More importantly, the costs of such mobile communication devices and mobile communication services have decreased rapidly due to various technological advancements within the industry.

Mobile telephones and other devices that use wireless networks are now commonplace. Today's mobile telephones are extremely portable, functionally superior, and inexpensive. For example, a typical modern mobile telephone can easily be placed in a handbag and/or a pocket without a carrier thereof noticing existence of the mobile telephone. Furthermore, mobile communication services and/or wireless service providers often offer sophisticated mobile telephones at no cost to persons who subscribe to wireless services offered therefrom. Accordingly, millions (if not billions) of individuals own and utilize mobile telephones.

With the mass amounts of individuals owning and using mobile telephones and/or mobile communication devices, mobile communication devices have grown to be more useful and evolved into storing and/or containing contact information (e.g., name, address, home phone number, cellular phone number, fax number, email, etc.). Conventional mobile communication devices facilitate entering information by employing keyboards, keypads, touch pads, touch-screens, speakers, stylus' (e.g., wands), writing pads, . . . yet deficiencies still exist relating to the input of information. Regardless of the technological advances within the mobile communications industry, users find entering, storing, and/or updating contact information within a mobile communication device pain-staking, mind-numbing, monotonous, and annoying.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to systems and/or methods that facilitate automatically updating contact information. A contact update component can receive identification data via an interface, wherein upon receiving a single piece and/or partial set of contact data, the contact update component can query the rest of the contact information and automatically add extra contact information without requiring the user manually enter such information using cumbersome mobile communication device input mechanisms. In other words, a subset of information can be received from, for instance, a network and then query the network to receive the additional data. The identification data can be, for example, a mobile communication device phone number, an electronic serial number (ESN), a mobile identification number (MIN), a system identification code (SID), etc. The contact update component can automatically provide contact information based at least in part upon the identification data to a mobile communication device and automatically update and/or store contact information relating to a disparate mobile communication device, user, and/or owner. In addition, the contact update component can gather and/or provide contact information via Internet protocol (IP), short message service (SMS), third generation (3G) mobile networks, and/or any machine to machine communication. Furthermore, the contact update component can automatically update contact information before a communication session, during a communication session, and/or after a communication session. In another aspect of the subject invention, the contact update component can format contact information to a particular format associated with a particular mobile communication device.

In accordance with one aspect of the subject invention, the contact update component includes an analyzer component that can analyze identification data to facilitate providing contact information to a mobile communication device. The analyzer component can identify what identification data is received, which can allow the determination of how to locate contact information associated therewith. Furthermore, the contact update component can include a lookup component that can determine the contact information associated to a user and/or an owner that relates to the identification data. The lookup component can utilize local resources and/or non-local resources to determine contact information that corresponds to the identification data. In one aspect, contact information can be provided by at least one of a database, a server, the Internet, a server in the Internet, a server on the Internet, a short messaging service center (SMSC), a host, an operator, a wireless service provider, a subscription service, a web-based service, a pre-populated database, a dynamically populated database, etc.

In accordance with another aspect of the subject invention, the contact update component can further include a security component that that employs at least one security technique in relation to access of contact information, wherein the security technique can be a human interaction proof (HIP), a voice verification, a verification question, a geographic region, a degree of defining relationship, a website (e.g., utilizing a degree of defining relationship), etc. In another aspect of the subject invention, the contact update component can further include a broker component that can implement a hand-shake technique to ensure approval of access to contact information. In still another aspect of the subject invention, the contact update component can include a filter component that can provide a tiered amount of contact information to a mobile communication device. In other aspects of the subject invention, methods are provided that facilitate automatically updating contact information.

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of an exemplary system that facilitates providing contact information based at least in part upon an identification data.

FIG. 2 illustrates a block diagram of an exemplary system that facilitates automatically populating contact information utilizing at least an identification data.

FIG. 3 illustrates a block diagram of an exemplary system that facilitates automatically updating and/or storing contact information based at least in part upon an identification data.

FIG. 4 illustrates a block diagram of an exemplary system that facilitates automatically providing a mobile communication device with an update to contact information across various wireless networks.

FIG. 5 illustrates a block diagram of an exemplary system that facilitates ensuring the integrity for accessing contact information.

FIG. 6 illustrates a block diagram of an exemplary system that facilitates automatically providing filtered contact information based at least in part upon an identification data.

FIG. 7 illustrates a block diagram of an exemplary system that facilitates automatically providing contact information based at least in part upon an identification data.

FIG. 8 illustrates a block diagram of contact information updates that facilitate automatically updating contact information.

FIG. 9 illustrates an exemplary methodology for automatically providing contact information based at least in part upon an identification data.

FIG. 10 illustrates an exemplary methodology that facilitates automatically providing contact information with associated security and/or filter techniques.

FIG. 11 illustrates a flow chart that facilitates utilizing an identification data to automatically provide secured and/or filtered contact information to a device.

FIG. 12 illustrates an exemplary networking environment, wherein the novel aspects of the subject invention can be employed.

FIG. 13 illustrates an exemplary operating environment that can be employed in accordance with the subject invention.

### DESCRIPTION OF THE INVENTION

As utilized in this application, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers. Furthermore, as utilized in this application, terms “mobile communication device,” “mobile communications service,” “wireless provider,” “cellular telephone,” “cell phone,” and “wireless device” and the like are intended to refer to wireless communications.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

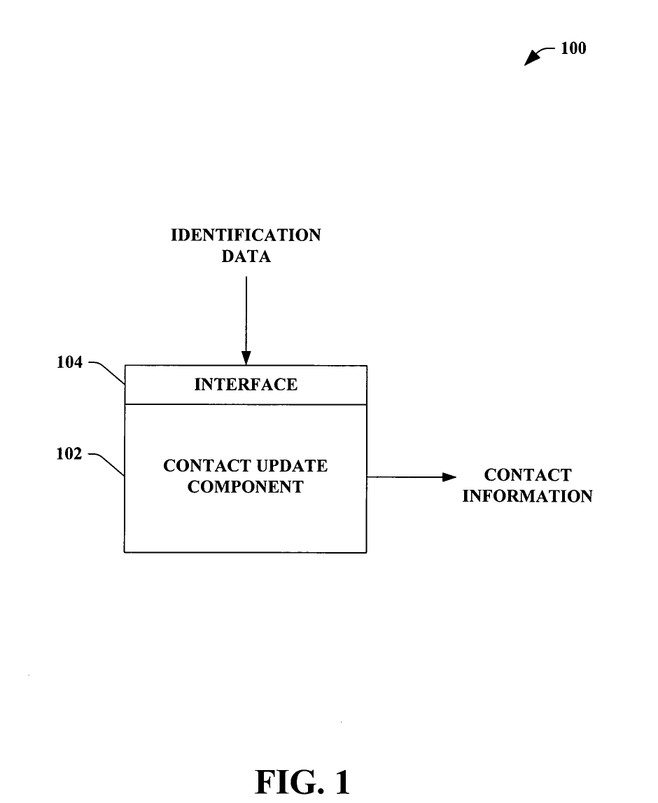

Now turning to the figures, FIG. 1 illustrates a system 100 that facilitates automatically gathering and/or providing contact information based at least in part upon identification data. A contact update component 102 can receive identification data via an interface 104. The identification data can be related to a mobile communication device (e.g., a cellular phone, a portable digital assistant (PDA), a wireless communications device, a smart phone, etc.), wherein the identification data can be, but is not limited to, a mobile communication device phone number (referred herein as “cell phone number”), an electronic serial number (ESN), a mobile identification number (MIN), a system identification code (SID), etc. The contact update component 102 can automatically provide contact information based at least in part upon the identification data. In one example, a single piece and/or partial set of contact data (e.g., a phone number) can be received, wherein the contact update component 102 can query the rest of the contact information via a network and automatically add extra contact information without requiring the user to manually enter such information using cumbersome mobile communication device input mechanisms. In other words, a subset of information can be received from, for instance, a network and/or information provider and then query such network and/or information provider to receive the additional data. It is to be appreciated that the contact information can be information related to another mobile communication device owner. For example, the contact information can include a name, an address, a home phone number, a cell phone number, a fax number, a work number, an email address, a website, an image, a picture, a screen name, a birth date, a pager number, . . . . In other words, the contact information can be any suitable data associated with a user and/or owner of a disparate mobile communication device. It is to be appreciated that the subject invention is not so limited to wireless communication and that any communication device with accommodating functionality can be implemented with the contact update component 102. For instance, a cordless telephone with a memory storage and/or address book can be utilized with the system 100 to allow the automatic update of contact information without the need to manually enter such contact information. In other words, the mobile communication device can also be a telephone with at least one of a memory storage and an address book.

In one example, a mobile communication device can have a cell phone number entered and/or as an input. Such cell phone number can be the sole contact information known by a user and/or stored within the mobile communication device. The cell phone number can be utilized by the contact update component 102 to automatically populate the mobile communication device with contact information associated to such cell phone number without the need to manually enter such contact information into the mobile communication device. In other words, a user need not manually enter and/or input the contact information associated with the cell phone number and indirectly of the user and/or owner of such cell phone number. It is to be appreciated that the population of the mobile communication device with contact information can occur before, after, and/or during a communication session (e.g., wireless communication, cellular call, etc.). Moreover, it is to be appreciated and understood that the population of the mobile communication device can be implemented by using the mobile communication device functionality such as, but not limited to, an address book, a storage medium, a user interface, and any combination thereof.

The contact update component 102 can provide the update, storage, enrichment, and/or population of contact information based at least in part upon the identification data (e.g., cell phone number, electronic serial number (ESN), mobile identification number (MIN), system identification code (SID), etc.). In order to provide contact information, the update component 102 can utilize a database, a server, the Internet, a server on the Internet, a server in the Internet, a short message service center (SMSC), a host, an operator, a wireless service provider, an Internet search, and the like. For instance, the contact update component 102 can utilize a website to search for contact information that corresponds to a cell phone number. It is to be appreciated that the contact update component 102 can obtain contact information based at least in part upon identification data and automatically provide the contact information to a mobile communication device without the need of manually entering such information.

Furthermore, the contact update component 102 can gather and/or provide the enrichment of contact information related to a mobile communication device by utilizing various wireless technologies, systems, and/or networks that provide voice channels, data channels, and the like. In one example, the contact update component 102 can provide contact information via Internet protocol (IP), short message service (SMS), third generation (3G) mobile networks, and/or any machine to machine communication while on a voice call and/or communication session.

The system 100 further includes the interface component 104, which provides various adapters, connectors, channels, communication paths, etc. to integrate the contact update component 102 into virtually any operating and/or database system(s). In addition, the interface component 104 can provide various adapters, connectors, channels, communication paths, etc. that provide for interaction with data and the contact update component 102. It is to be appreciated that although the interface component 104 is incorporated into the contact update component 102, such implementation is not so limited. For instance, the interface component 104 can be a stand-alone component to receive or transmit the data in relation to the system 100.

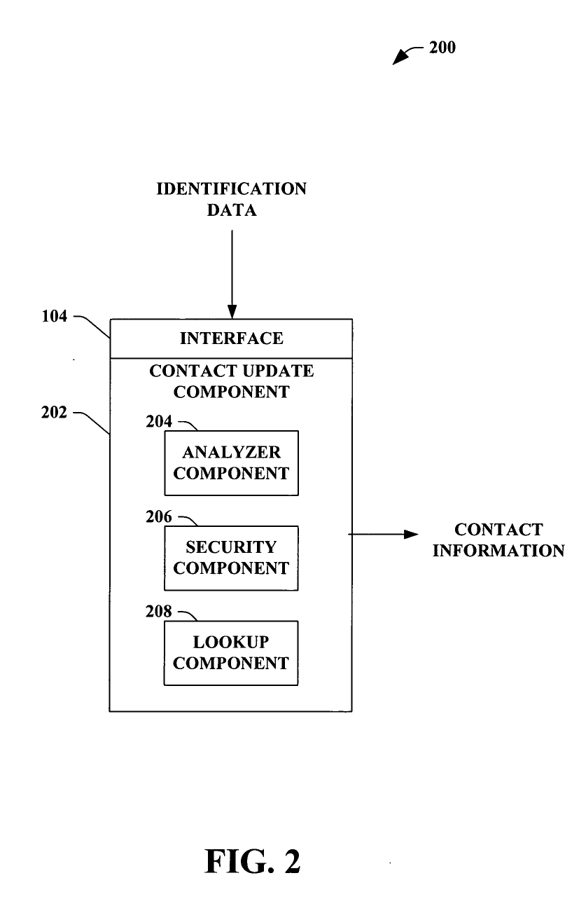

FIG. 2 illustrates a system 200 that facilitates automatically populating contact information utilizing at least identification data. Identification data can be received by the interface 104, wherein a contact update component 202 can utilize such identification data to provide contact information. The identification data can include, for instance, a cell phone number, an electronic serial number (ESN), a mobile identification number (MIN), and a system identification code (SID). For example, an address book within a cellular phone on a 3G wireless network can be automatically updated for a specific phone number with contact information without the need of a user to enter such contact information. It is to be appreciated that the contact update component 202 can be substantially similar to the contact update component 102 of FIG. 1.

It is to be appreciated that the contact information can be formatted to particularly adapt to any suitable mobile communication device. For example, various mobile communication devices include disparate address books and/or information storage techniques/systems. In other words, the contact information can be formatted for suitable display on the target mobile communication device for automatic update. In particular, a cellular phone can employ an address book that allows the storage of a name, a home phone number, a work number, and a home address. In such example, the corresponding contact information can include more and/or less information. Thus, the contact information can be automatically formatted to adapt and/or update to such mobile communication device (e.g., reduce and/or leave information fields empty based at least in part upon the address book format).

The contact update component 202 can include an analyzer component 204 that can analyze the identification data. The analyzer component 204 can determine what identification data is received, which can allow the system 200 to determine how to locate contact information associated therewith. For instance, the analyzer component 204 can determine whether the identification data is one of a cell phone number, an electronic serial number (ESN), a mobile identification number (MIN), and a system identification code (SID). In particular, the analyzer component 204 can analyze a cell phone number to determine a wireless service provider, a geographic location, etc. It is to be appreciated that such analysis associated to the analyzer component 204 can be utilized by at least a lookup component 208 (discussed infra).

The contact update component 202 can further include a security component 206 that employs at least one security technique in relation to access of contact information. For example, a request for contact information can be made by, for example, a mobile communication device and/or a wireless signal, wherein the security component 206 can provide security techniques to ensure the approval of sending contact information to the request and/or the mobile communication device. Security techniques that can be employed include a human interaction proofs (HIPS), voice verification, verification questions, a geographic region, a degree of defining relationship, a website (e.g., utilizing a degree of defining relationship), etc. It is to be appreciated that accessibility settings can be stored and/or set according to a user of which the contact information relates. In one example, a user can determine a list of individuals that correspond to his/her contact information, in which the security component 206 can determine if a requesting mobile communication device and/or user is not listed, the contact information will not be accessible. In another example, a user can provide a security question that, if answered correctly, provides access to the user's contact information. Thus, a requesting mobile communication device and/or user can correctly answer such question via text, voice, image, etc. In still another example, the access of contact information can be based at least in part upon a geographic location defined by a user to which the contact information relates. In other words, the user can allow access to any request made within a region surrounding and/or including a hometown.

The contact update component 202 can further include a lookup component 208 that can determine the contact information associated to a user and/or an owner that relates to the identification data. In particular, the lookup component 208 can provide contact information based at least in part upon a cell phone number. It is to be appreciated that the lookup component 208 can interact with the security component 206 and/or the analyzer component 204 in order to facilitate looking up contact information. For example, based at least in part upon the analysis of the identification data, the lookup component 208 can find and/or locate contact information accordingly. It is to be appreciated that the lookup component 208 can utilize at least one of the following to find and/or locate contact information: a database, a server, a short message service center (SMSC), the Internet, a server on the Internet, a server in the Internet, a host, an operator, a wireless service provider, a subscription service, a web-based search, a pre-populated database, . . . . In other words, the lookup component 208 can find and/or locate contact information that corresponds to the identification data, wherein the contact information can be automatically updated and/or stored to a mobile communication device.

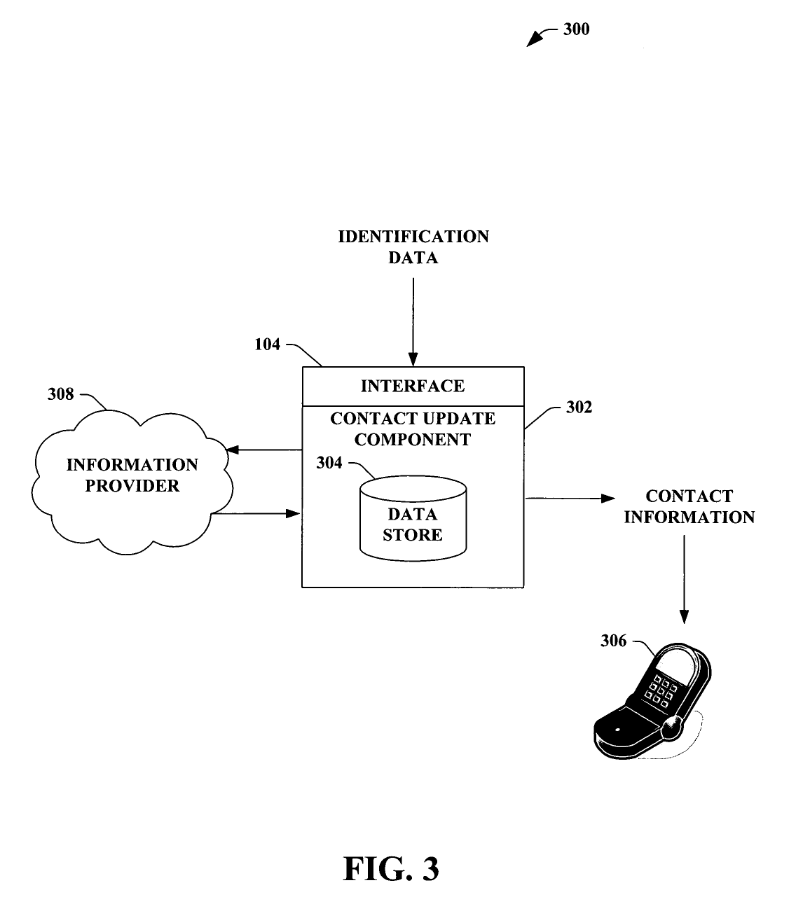

FIG. 3 illustrates a system 300 that facilitates automatically updating and/or storing contact information based at least in part upon identification data. A contact update component 302 can receive identification data (e.g., a cell phone number, an electronic serial number (ESN), a mobile identification number (MIN), and a system identification code (SID)), wherein the identification data can be utilized to determine contact information to automatically update a mobile communication device 306 (also referred to as the “cellular phone 306”). The contact update component 302 can receive the identification data via the interface 104. In one example, the identification data can be sent by a request from the cellular phone 306. It is to be appreciated that the contact update component 302 can be substantially similar to the contact update component 202 and 102 of FIGS. 2 and 1 respectively.

The contact update component 302 can further include a data store 304 that can provide contact information that corresponds to identification data. The contact information can be, but is not limited to, a name, an address, a home phone number, a cell phone number, a fax number, a work number, an email address, a website, an image, a screen name, a birth date, a pager number, . . . . In one example, the contact update component 302 can utilize a table containing cell phone numbers and corresponding contact information. The data store 304 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 304 of the subject systems and methods is intended to comprise, without being limited to, these and any other suitable types of memory. In addition, it is to be appreciated that the data store 304 can be a server and/or database.

The contact update component 302 can utilize an information provider 308 that can provide contact information based at least in part upon the identification data. The information provider 308 can be, but is not limited to, a database, a server, the Internet, a server in the Internet, a server on the Internet, a short messaging service center (SMSC), a host, an operator, a wireless service provider, a subscription service, a web-based service, a pre-populated database, a dynamically populated database, . . . . For example, the information provider 308 can be a subscription service, wherein users can actively subscribe to a contact information providing service utilizing the system 300. In another example, the information provider 308 can be a wireless service provider, wherein customers utilizing such wireless service provider can provide contact information to other customers utilizing the system 300. It is to be appreciated and understood that the information provider 308 can be any suitable contact information providing technique and the above examples are not to be limiting on the subject invention.

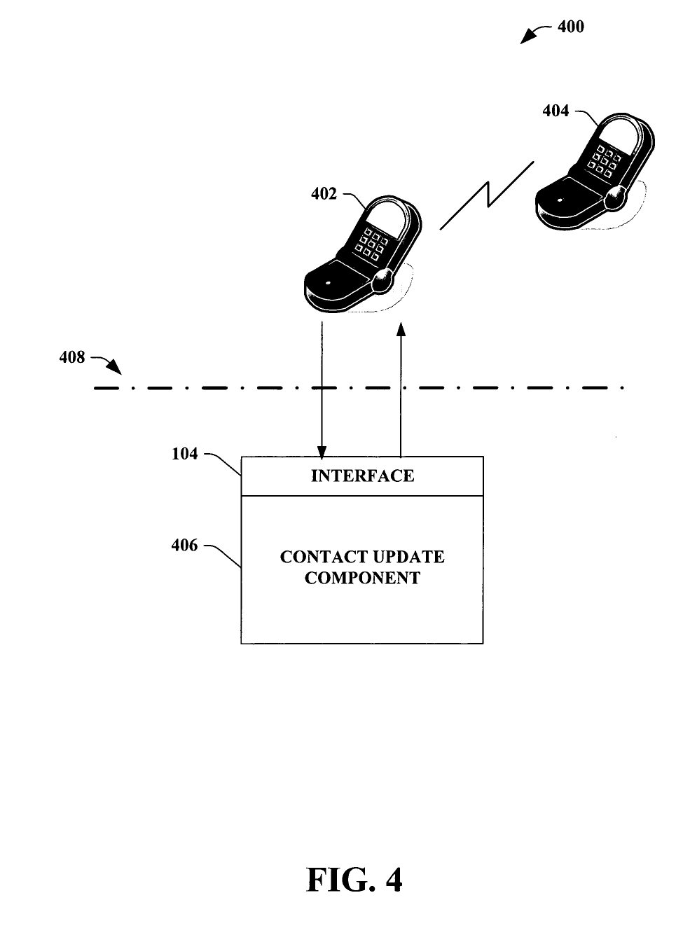

FIG. 4 illustrates a system 400 that facilitates automatically providing a mobile communication device with an update to contact information across various wireless networks. A mobile communication device 402 can employ a communication session with a mobile communication device 404. A request can be made by the mobile communication device 402 to update contact information relating to the mobile communication device 404. Such request can include identification data such as, but not limited to a cell phone number related to the mobile communication device 404. A contact update component 406 can receive the identification data (including the request) via the interface 104, wherein the contact update component 406 can automatically update contact information to the mobile communication device 402. It is to be appreciated that the contact information can be updated and/or stored in the mobile communication device 402 during the communication session, after the communication session, and/or before the communication session. Moreover, it is to be understood that the contact update component 406 can be substantially similar to the contact update component 302, 202, and 102 of FIGS. 3, 2, and 1 respectively.

The contact information can be provided to the mobile communication device 402 utilizing any suitable machine to machine communication 408. The machine to machine communication 408 can include an Internet protocol (IP), a short message service (SMS), and a third generation (3G) mobile network. For example, before short message service (SMS), during a communication session, no data could only be transferred after and/or before the session. In such case, after and/or before the session, a data connection could be opened to retrieve contact information and provide to a user. Yet, with short message service (SMS), contact information can be sent/received to a user during the communication session. Utilizing newer networks, a data channel and a voice channel can be opened at the substantially similar time (e.g., concurrently accessing contact information and fetching the contact information).

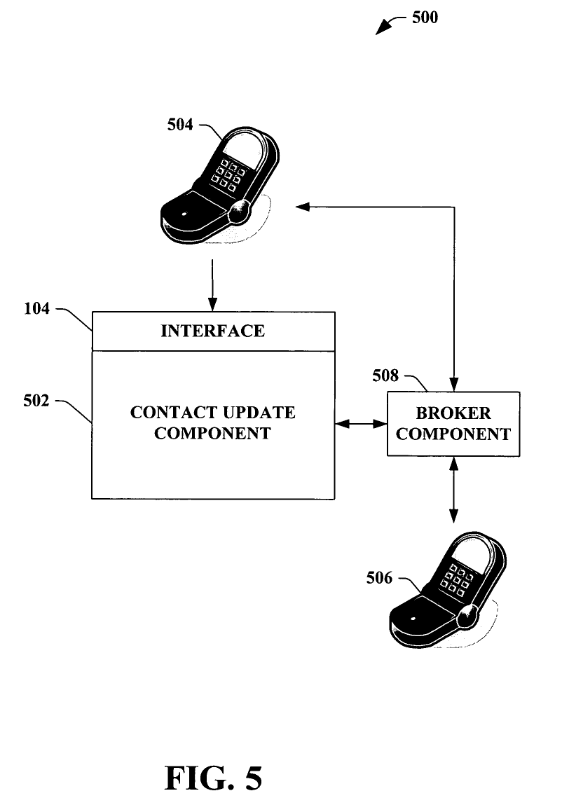

FIG. 5 illustrates a system 500 that facilitates ensuring the integrity for accessing contact information between at least two mobile communication devices. A contact update component 502 can receive a cell phone number related to a cell phone 506 from a cell phone 504, wherein the cell phone 504 contains only the cell phone number as contact information stored and/or entered therein. The contact update component 502 can automatically provide additional contact information (e.g., a name, an address, a home phone number, a cell phone number, a fax number, a work number, an email address, a website, an image, a picture, a screen name, a birth date, a pager number, etc.). The contact update component 502 can be substantially similar to the contact update component 406, 302, 202, and 102 of FIGS. 4, 3, 2, and 1 respectively.

A broker component 508 can implement a hand-shake technique to ensure approval of access to additional contact information before an automatic update to the contact information contained within the cell phone 504. For example, upon a request from the cell phone 504 to access additional contact information relating to the cell phone number associated to a user and/or owner of the cell phone 506, the broker component 508 can instantiate an approval from such user and/or owner of the cell phone 506. In other words, the user and/or owner of the cell phone 506 can be informed of the cell phone 504 and/or user associated therewith and can give approval of the release of additional contact information. Upon approval, the additional contact information can be automatically updated to the cell phone 504. It is to be appreciated that the broker component 508 can utilize any suitable brokering technique, hand-shaking technique, and/or any combination thereof to ensure the approval of the update of contact information.

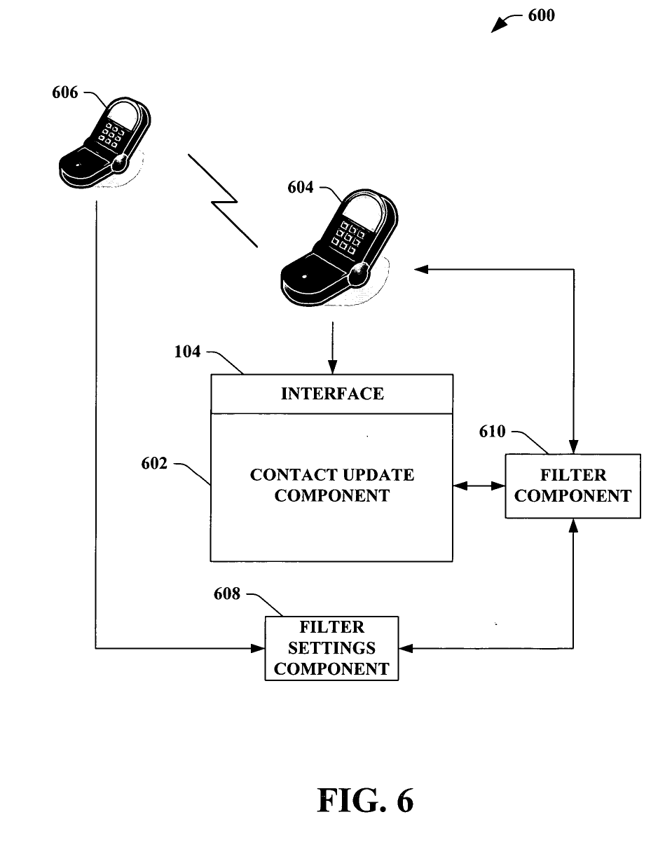

FIG. 6 illustrates a system 600 that facilitates automatically providing filtered contact information based at least in part upon identification data. A contact update component 602 can provide contact information based at least in part upon a cell phone number. Furthermore, the contact update component 602 can receive the cell phone number via the interface 104. It is to be appreciated that the contact update component 602 can be substantially similar to the contact update component 502, 406, 302, 202, and 102 of FIGS. 5, 4, 3, 2, and 1 respectively.

A cell phone 604 can communicate with a cell phone 606, wherein the cell phone 604 does not have contact information related to the cell phone 606. The cell phone 606, a user, and/or respective owner can provide settings related to the access of contact information to a filter settings component 608. The filter settings component 608 can provide the settings for the cell phone 606 to a filter component 610. In one example, the contact information can be tiered such that a level of approval can be associated to an amount of contact information. For example, a high level of approval can correspond to access to all and/or a majority of contact information. Upon the request of the cell phone 604 to provide contact information that relates to the cell phone 606, the contact update component 602 can provide such contact information to a filter component 610. The filter component 610 can filter the contact information to the cell phone 604 based at least in part upon the setting received by the filter settings component 608. In other words, the cell phone 604 can receive a portion of contact information based at least in part upon settings associated to a user and/or owner of the cell phone 606.

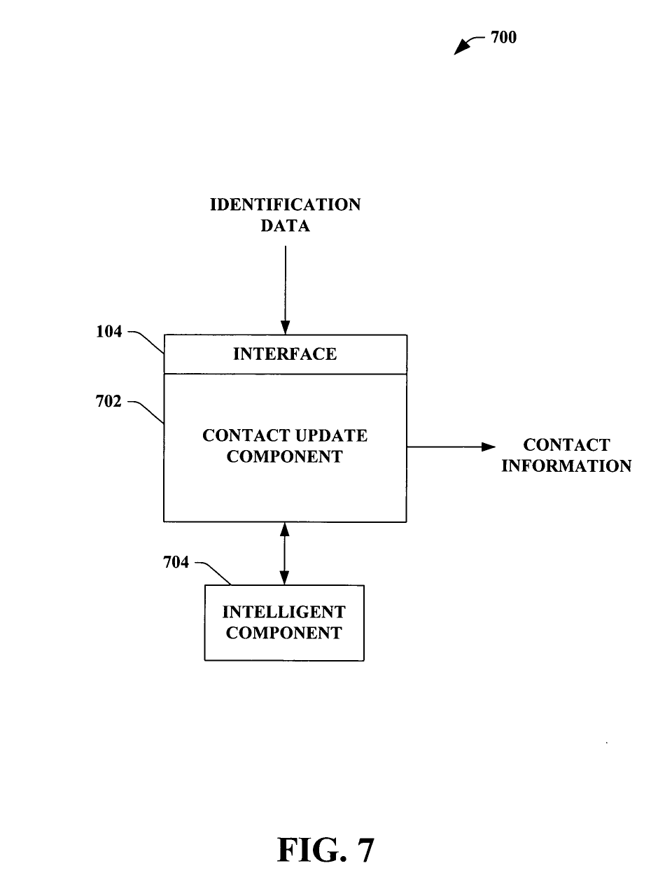

FIG. 7 illustrates a system 700 that employs intelligence to facilitate automatically providing contact information based at least in part upon identification data to automatically update contact information contained within a mobile communication device. A contact update component 702 can analyze identification data, and determine contact information associated therewith, in which the contact information is automatically updated to a mobile communication device. It is to be appreciated that the contact update component 702 can be substantially similar to the contact update component 602, 502, 406, 302, 202, and 102 in FIGS. 6, 5, 4, 3, 2, and 1 respectively. The system 700 further includes an intelligent component 704. The intelligent component 704 can be utilized by the contact update component 702 to facilitate providing contact information, security, and/or filtering. For example, the intelligent component 704 can be utilized to analyze identification data, determine approval of a request, implement security, employ filtering, determine contact information access, etc.

It is to be understood that the intelligent component 704 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

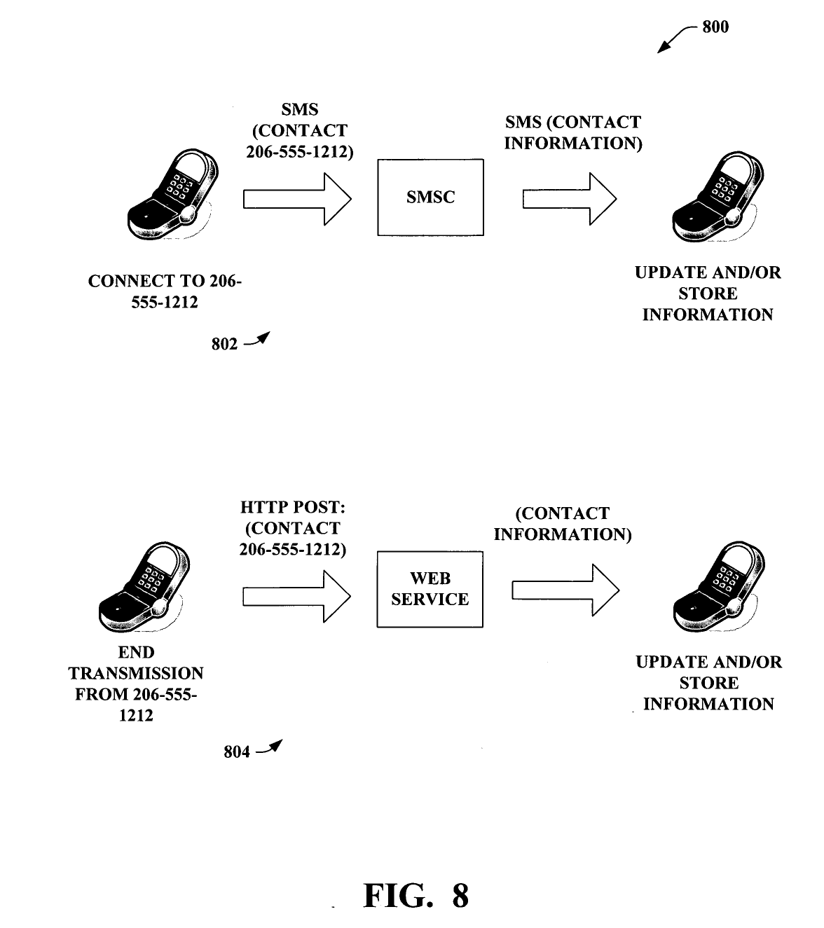

FIG. 8 illustrates contact information updates 800 that facilitate automatically updating contact information. A contact information update 802 can update contact information during a communication session. A cell phone can connect to another cell phone with a cell phone number depicted as 206-555-1212. During the communication session, a short message service center (SMSC) can provide contact information to the cell phone to allow the automatic update of contact information related to the cell phone number. In other words, the cell phone can update and/or store the contact information that is automatically received (once accepted and/or approved). For example, the contact information associated with the cell phone number 206-555-1212 can be SMS (Contact Zeke Koch, 1234 14^{th} St. Redmond Wash. 98052), wherein such contact information can be automatically updated to the cell phone without manual input.

Continuing with FIG. 8, a contact information update 804 can update contact information at the end of a communication session. The cell phone can terminate the communication session with the cell phone number 206-555-1212. A post to a hypertext transfer protocol (HTTP) can be utilized to provide contact information that corresponds to the cell phone number via a web service. The web service can send the contact information to the cell phone, wherein the cell phone can automatically update and/or store the contact information related to the cell phone number.

It is to be appreciated that the contact information update can be provided to a mobile communication device before, during, and/or after a communication session with a cell phone. Furthermore, the contact information update can be provided and/or accessed via voicemail, mailbox, text, an email, a short message service, a multimedia messaging system, an electronic message, and any suitable technique associated with a missed call. For example, a user can miss a call on a cell phone, wherein the user can later check such voicemail allowing the contact information update to be provided (e.g., during, after, and/or before such checking of the voicemail). In other words, the user need not be in contact for incoming call in order for the contact information update to automatically be utilized.

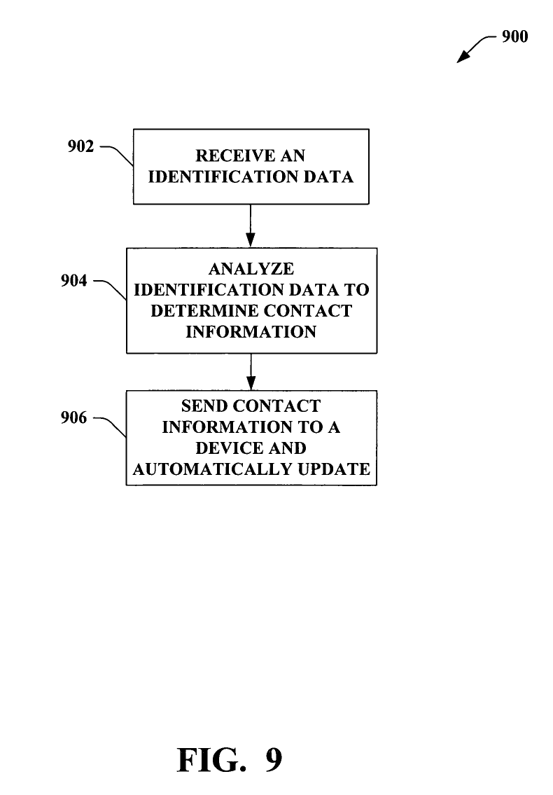

FIGS. 9-11 illustrate methodologies and/or flow charts in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 9 illustrates a methodology 900 for automatically providing contact information based at least in part upon an identification data. At reference numeral 902, an identification data can be received. The identification data can include, but is not limited to, a cell phone number, an electronic serial number (ESN), a mobile identification number (MIN), a system identification code (SID), etc. The identification data can relate to any suitable mobile communication device (e.g., a cellular phone, a portable digital assistant, a wireless communications device, etc.), wherein the mobile communication device can provide the identification data by utilizing suitable wireless networks (e.g., Internet protocol (IP), short message service (SMS), third generation (3G) mobile networks, and/or any machine to machine communication, etc.).

At reference numeral 904, the identification data can be analyzed to determine corresponding contact information. For instance, a cell phone number can correspond to a cell phone with an owner and/or user, wherein the owner and/or user can have personal/contact information associated therewith. In one example, the contact information can include a name, an address, a home phone number, a cell phone number, a fax number, a work number, an email address, a website, an image, a picture, a screen name, a birth date, a pager number, . . . . The analysis of the identification number can utilize a lookup and/or table technique utilizing, for instance an information provider, wherein the information provider can be, but is not limited to, a database, a server, the Internet, a server on the Internet, a server in the Internet, a short messaging service center (SMSC), a host, an operator, a wireless service provider, a subscription service, a web-based service, a pre-populated database, a dynamically populated database, . . . .

At reference numeral 906, the contact information can be sent to the requesting mobile communication device. The contact information can be sent via any suitable wireless network (e.g., Internet protocol (IP), short message service (SMS), third generation (3G) mobile networks, and/or any machine to machine communication, etc.). In one example, the contact information can be formatted specifically to adapt to the storage techniques associated with a particular mobile communication device. Such formatting can include adding, condensing, and eliminating content of the contact information in order to be arranged within the mobile communication device. In other words, mobile communication devices utilize various address books and formats and the contact information can be formatted accordingly before being transmitted to the mobile communication device. The contact information can be automatically updated to the mobile communication device without the need for the user and/or owner to manually enter and/or type such contact information into the mobile communication device and/or address book and/or memory storage. It is to be appreciated that the automatic contact information update can be approved by the recipient, yet such approval can be previous to the transmission of the contact information. In other words, the subject invention facilitates the automatic update of contact information within a mobile communication device without the need of manually entering and/or typing such contact information into associated address book and/or memory storage.

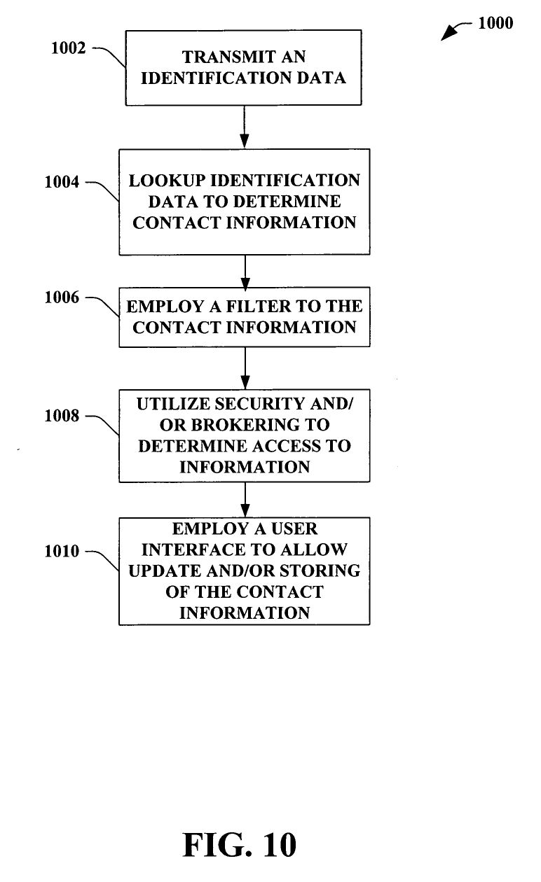

FIG. 10 illustrates a methodology 1000 that facilitates automatically providing contact information with associated security and/or filter techniques. At reference numeral 1002, an identification data can be transmitted from a mobile communication device. The identification data can be, for instance, a cell phone number. Such transmission of identification data can be sent before, during, and/or after a communication session between at least two mobile communication devices. It is to be appreciated that the identification data can be related to an owner and/or user of another mobile communication device that has contact information associated therewith. At reference numeral 1004, a lookup on the identification data to determine the corresponding contact information. It is to be appreciated that any suitable information provider can be utilized in order to provide the contact information.

At reference numeral 1006, a filter can be employed to the contact information before transmission to a requesting mobile communication device. The filter can be set by, for example, the user to which such contact information relates. Additionally, the filter can allow for the access to levels and/or tiers of information based on a corresponding level setting and/or tier setting. At reference numeral 1008, security and/or brokering techniques can be employed to determine accessibility to contact information to the requesting mobile communication device. For example, security techniques can include a human interaction proof (HIP), voice verification, verification questions, a geographic region, a degree of defining relationship, a website (e.g., utilizing a degree of defining relationship), etc. Moreover, a brokering technique can be utilized such that a handshake is enacted between the requesting mobile communication device and the user and/or owner associated to the contact information. For example, the requesting mobile communication device can await an approval for receiving the contact information from the mobile communication device that relates to the identification data (e.g., cell phone number). At reference numeral 1010, a user interface can be employed to allow an automatic update and/or storing of the contact information to the requesting mobile communication device. It is to be appreciated that the user interface can be implemented on a particular format relating to the requesting mobile communication device. Moreover, the automatic contact information update and/or storing can be enacted before, during, and/or after a communication session. In one example, the automatic update and/or storing can be implemented after a missed call and/or reception of a voicemail on the mobile communication device.

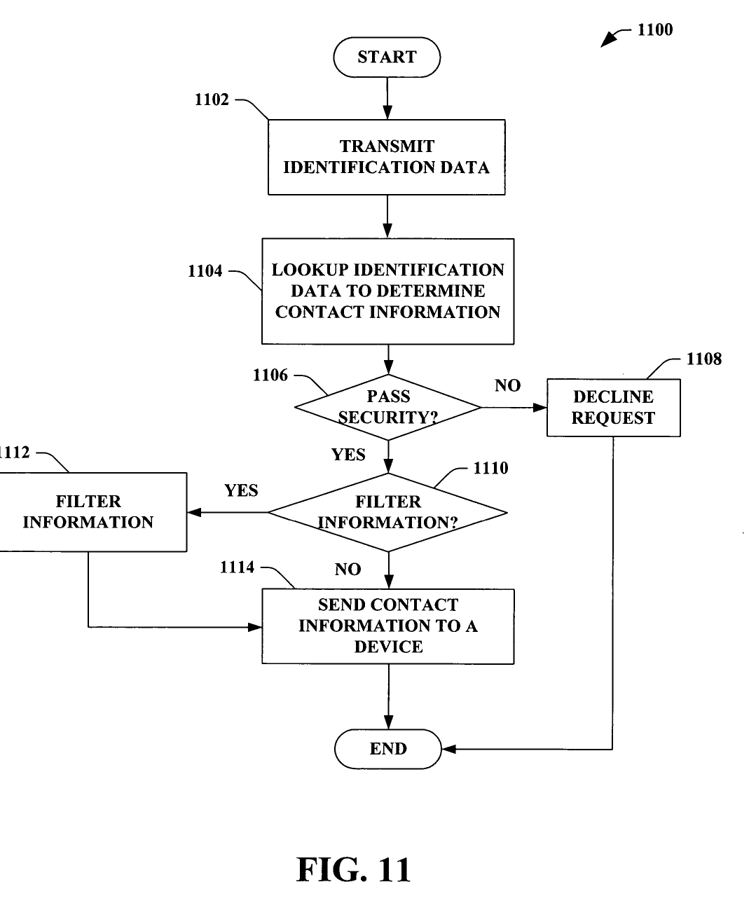

FIG. 11 illustrates a flow chart 1100 that facilitates utilizing an identification data to automatically provide secured and/or filtered contact information to a device. At reference numeral 1102, identification data can be transmitted by a mobile communication device such as a cell phone. The identification data can be a cell phone number that relates to a user and/or an owner of a mobile communication device, wherein the user and/or owner has contact information related therewith. At reference numeral 1104, the identification data is analyzed to determine contact information that corresponds to the identification data. For example, the contact information can be determined by utilizing a database, a server, the Internet, a server on the Internet, a server in the Internet, a short messaging service center (SMSC), a host, an operator, a wireless service provider, a subscription service, a web-based service, a pre-populated database, a dynamically populated database, . . . . At reference numeral 1106, a determination is made whether security techniques have been passed. If security is not passed, the method proceeds to reference numeral 1108, where the request for contact information is declined. If security is passed, the method continues at reference numeral 1110, where a determination is made whether the contact information is to be filtered. If the contact information is to be filtered, the process continues at 1112, where the contact information is filtered and/or tiered. Once filtered and if the contact information is not to be filtered, the process continues to reference numeral 1114, where the contact information can be sent and automatically updated and/or stored to a mobile communication device. In other words, the contact information is automatically entered without the user and/or owner of the mobile device manually entering the contact information.

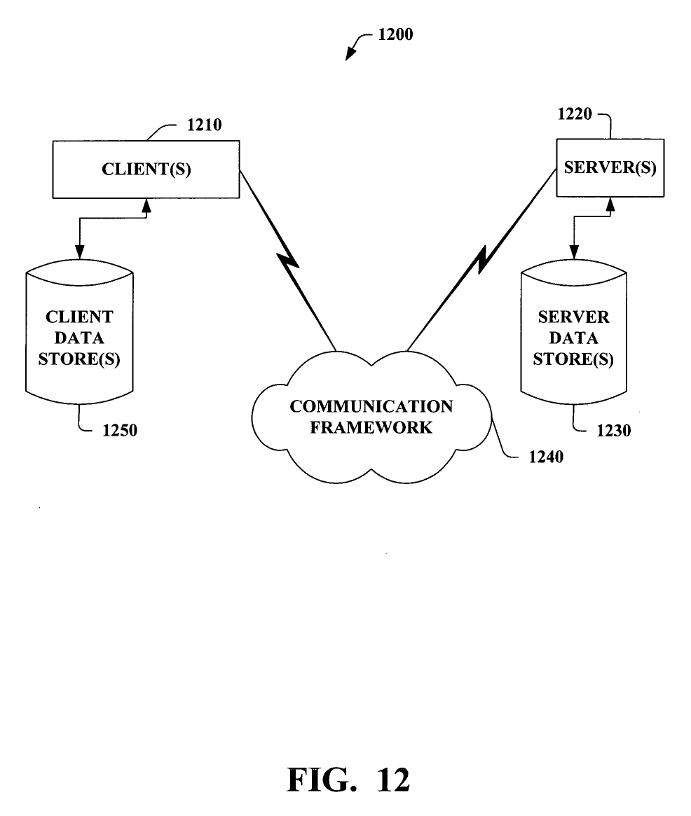

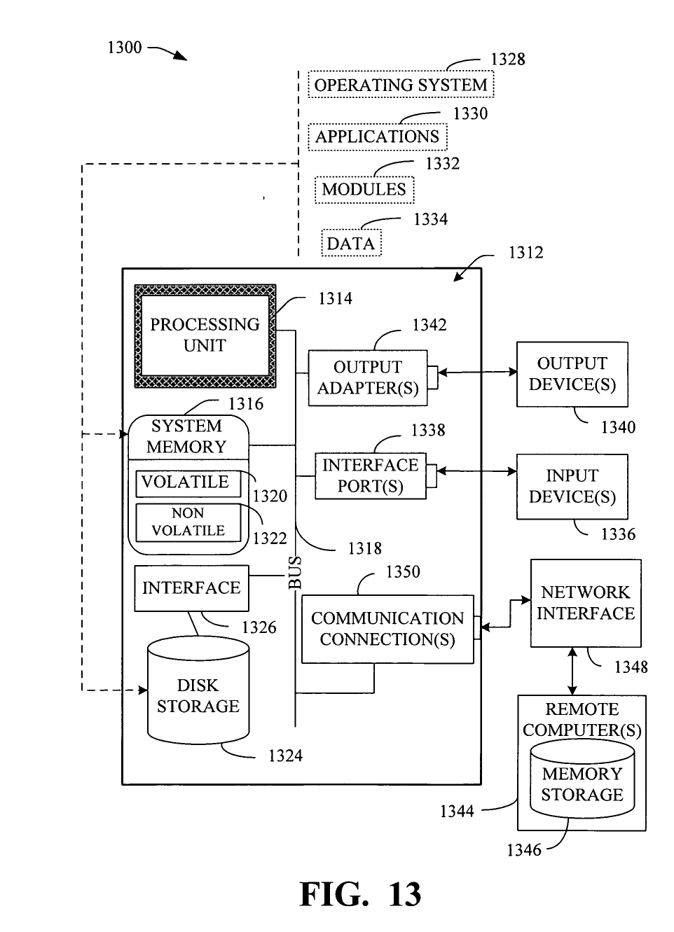

In order to provide additional context for implementing various aspects of the subject invention, FIGS. 12-13 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 12 is a schematic block diagram of a sample-computing environment 1200 with which the subject invention can interact. The system 1200 includes one or more client(s) 1210. The client(s) 1210 can be hardware and/or software (e.g., threads, processes, computing devices). The system 1200 also includes one or more server(s) 1220. The server(s) 1220 can be hardware and/or software (e.g., threads, processes, computing devices). The servers 1220 can house threads to perform transformations by employing the subject invention, for example.

One possible communication between a client 1210 and a server 1220 can be in the form of a data packet adapted to be transmitted between two or more computer processes. The system 1200 includes a communication framework 1240 that can be employed to facilitate communications between the client(s) 1210 and the server(s) 1220. The client(s) 1210 are operably connected to one or more client data store(s) 1250 that can be employed to store information local to the client(s) 1210. Similarly, the server(s) 1220 are operably connected to one or more server data store(s) 1230 that can be employed to store information local to the servers 1240.

With reference to FIG. 13, an exemplary environment 1300 for implementing various aspects of the invention includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in the suitable operating environment 1300. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the subject invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (JSB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates automatically updating contact information, comprising:
an interface that receives identification data related to a first mobile communication device; and
a contact update component that provides contact information associated with the first mobile communication device to a second mobile communication device based at least in part upon identification data and automatically updates such contact information.

2. The system of claim 1, the identification data is at least one of the following: a cell phone number; an electronic serial number (ESN); a mobile identification number (MIN); a telephone number; and a system identification code (SID).

3. The system of claim 1, one or more of the first mobile communication device and the second mobile communication device are at least one of the following: a cellular phone; a portable digital assistant (PDA); a wireless communications device; a telephone with at least one of a memory storage and an address book; and a smart phone.

4. The system of claim 1, the contact information relates to a user on the first mobile communication device and is at least one of the following: a name; an address; a home phone number; a cell phone number; a fax number; a work number; an email address; a website; an image; a picture; a screen name; a birth date; and a pager number.

5. The system of claim 1, the update is provided to one or more of an address book and a memory storage associated with the second mobile communication device by at least one of a user approval and an automatic manner.

6. The system of claim 1, the update employed by utilizing at least one of the following: an Internet protocol (IP); a short message service (SMS); a third generation (3G) mobile network; and a machine to machine communication.

7. The system of claim 1, the contact information is formatted to a particular format associated with one or more of the address book and memory storage related to the second mobile communication device.

8. The system of claim 1, the update occurs during at least one of the following: before a communication session; during a communication session; and after a communication session.

9. The system of claim 8, the update occurs upon the notification of at least one of a missed call; an email; a short message service; a multimedia messaging system; an electronic message; and a voicemail.

10. The system of claim 1, further comprising an information provider that provides the contact information and is at least one of the following: a database; a server; a server on the Internet; a server in the Internet; a short messaging service center (SMSC); a host, an operator; a wireless service provider; a subscription service; a web-based service; a pre-populated database; a dynamically populated database; and a web-based search.

11. The system of claim 1, the contact update component further comprising a security component that provides a security technique in relation to access of contact information.

12. The system of claim 11, the security technique is at least one of the following: a human interaction proof (HIP); a voice verification; a verification question; a geographic region; a degree that defines relationship; and a website.

13. The system of claim 1, further comprising a broker component that implements a hand-shake technique to ensure approval of access to contact information between at least the first mobile communication device and the second mobile communication device.

14. The system of claim 1, further comprising a filter component that can provide a tiered amount of contact information to the second mobile communication device.

15. A computer readable medium having stored thereon the components of the system of claim 1.

16. A computer-implemented method that facilitates automatically updating contact information, comprising:
receiving an identification data that relates to a first mobile communication device;
analyzing the identification data;
determining contact information that corresponds to the identification data; and
transmitting contact information to a second mobile communication device.

17. The method of claim 16, further comprising storing the contact information to at least one of an address book and a memory storage associated with the second mobile communication device.

18. The method of claim 16, further comprising:
employing a filter to contact information;
utilizing a security technique in relation to access to contact information;
implementing a brokering technique to approve access to contact information; and
invoking a user interface on the second mobile communication device to display contact information.

19. A data packet that communicates between a contact update component and an interface, the data packet facilitates the method of claim 16.

20. A computer-implemented system that facilitates automatically updating contact information, comprising:
means for receiving identification data related to a first mobile communication device; and
means for providing contact information to a second mobile communication device and automatically updating such contact information.
